(19) United States
(12) Patent Application Publication
(10) Pub. No.: US 2018/0134316 A1
(43) Pub. Date: May 17, 2018

(54) CHASSIS COMPONENT, METHOD FOR PRODUCING SAME, AND USE

(71) Applicants: THYSSENKRUPP STEEL EUROPE AG, Duisburg (DE); thyssenkrupp AG, Essen (DE)

(72) Inventors: Peter KLAUKE, Schwerte (DE); Melanie DINTER, Recklinghausen (DE); Oliver KLEINSCHMIDT, Dortmund (DE); Tobias LEWE, Münster (DE); Kai-Uwe JENTSCH, Moers (DE)

(73) Assignees: THYSSENKRUPP STEEL EUROPE AG, Duisburg (DE); thyssenkrupp AG, Essen (DE)

(21) Appl. No.: 15/551,318

(22) PCT Filed: Jan. 28, 2016
(86) PCT No.: PCT/EP2016/051802

§ 371 Date: Aug. 16, 2017

(30) Foreign Application Priority Data
Feb. 20, 2015 (DE) 102015203128.4

(51) Int. Cl. B62D 21/11; B62D 23/00

(52) U.S. Cl. CPC B62D 21/11; B62D 23/005

(57) ABSTRACT

A chassis component may include at least one first component part made from a structure-borne soundproofing composite material with a first metal layer, at least one second metal layer, and at least one damping layer. The damping layer may be positioned partly or entirely across a surface between the metal layers. In some cases, the first metal layer and the second metal layer may be thermally joined together in at least one place. In addition, a material thickness of the first metal layer is at least 0.2 mm. Moreover, the present disclosure relates to corresponding methods for producing such chassis components.

Chassis component containing at least one first component part made from a structure-borne sandproofing composite material with a first metal layer, at least one second metal layer and at least one damping layer, which is arranged partly or entirely across the surface between the metal layers. Moreover, the invention relates to two corresponding methods for the production of same, as well as a corresponding use.

The damping of structure-borne sound in automotive design is one of the most important measures in the designing of balanced and harmonious vehicle acoustics. The noise and vibration level in automotive design is primarily dominated by three sources: 1. the drive unit, including auxiliary units, brakes, transmission and powertrain components, as well as intake and exhaust line; 2. the air stream; 3. the interaction between the roadway and the vehicle.

The share of the particular source in the overall noise and vibration level is dependent on factors such as driving speed, engine load, roadway quality and vehicle model. In particular, the excitation caused by roadway irregularities such as lateral grooves, asphalt strips, manhole covers or rough road surfaces are generally perceived by the vehicle passengers as very much a nuisance. In particular, the impulsive characteristics of these events result in noises which are especially consciously perceived and thus result in a high interference effect largely independent of the vehicle model.

New challenges are being created for so-called passive acoustical design by the continuing efforts of the OEMs (Original Equipment Manufacturers) to reduce the vehicle weight and further lower the fuel consumption. But these measures stand in conflict with the increasing demands for driving dynamics, driving comfort, and acoustical comfort. If the OEMs want to achieve the emission targets set by the lawmakers for 2020 of 95 g/km CO2, heretofore untouched vehicle components must also be placed in the focus of acoustics.

The investigation of the NVH (Noise Vibration Harshness) vehicle characteristics makes it clear that, besides the design of the body and chassis subsystems, the connection elements such as vibration dampers, chassis springs, and elastomer-based bearings in particular are of central importance to the transmission of structure-borne sound. Measurements have shown that so-called stick-slip effects between moving components such as dampers or rubber sleeves result in significantly worse transmission behavior, especially at low amplitudes, which typically prevail at higher frequencies. The vibration-reducing properties of the components do not come into play here on account of the large static friction—and the associated breakaway forces and moments. A dynamic hardening of rubber at high frequencies and low amplitudes as well as an aging and hardening of the rubber over time also result in poor structure-borne sound properties.

In economy vehicles with lesser comfort demands, rubber bearings are normally used, wherein due to the necessary compromise between driving dynamics and driving comfort there is a tendency to use rather stiff bearings with a large material damping. But a high material damping in rubber bearings leads to significantly worse vibroacoustic transmission qualities, although it is absolutely necessary in order to limit the resonance peaks in the relevant frequency range for driving dynamics. In the higher priced vehicle segment, therefore, only technically very costly rubber bearings are used, mostly with direction-selective stiffness, a multilayered structure, as well as additional comfort bearings with double isolation.

In the European patent 2 390 120, for example, an embodiment is disclosed for avoiding a transmission of structure-borne sound between chassis and body in a vehicle. As described in this document, a sandwich material is arranged as a structure-borne sound absorbing element between a spring strut cover and a wheel arch suspension dome, wherein as one variant of the teaching not covered by the invention the entire spring strut cover may consist of a sandwich material. The core layer made from polyurethane used may be effective in regard to a reducing of structure-borne sound, but this core layer is not suitable on account of its slight temperature resistance for other components of a chassis, especially steering gears, such as cross links, longitudinal links, trailing links, double cross links, torsion beam axles, auxiliary frames, wheel disks, etc., which are conventionally subjected to a CDC (cathode dip coating) process and in most instances are thermally joined. Also in the area of the brakes and exhaust gas lines temperatures of more than 200° C. may briefly occur, for example, so that there is a danger of the the core layer made from polyurethane decomposing and thus a failure of the chassis component cannot be ruled out.

The problem of the invention is therefore to provide a chassis component which overcomes the aforementioned deficiencies and can contribute to increased driving comfort or acoustical comfort in the vehicle.

The problem is solved for the chassis component in that the damping layer of the component part is an adhesive layer made from a silicone-containing material.

The inventors have discovered that various chassis components, regardless of the already customary measures of today for structure-borne sound isolation in the area of the bearings, should furthermore be outfitted in themselves with an adequately large passive structure-borne soundproofing in order to be able to meet the increasing demands for driving comfort and acoustical comfort without installing additional masses. Thanks to the use of an adhesive layer made from a silicone-containing material, not only can it be assured that transient temperatures above 200° C. will not negatively influence the component part, but also a thermal joining is assured without negative influence on the quality of the structure-borne soundproofing composite material, depending on the chassis component. The silicone-containing material may be, for example, silicone-containing resins or silicone rubber, which can be crosslinked in particular. As the thermal joining, besides the conventional metal inert gas (MIG/MAG/TIG) welding, oxyacetylene welding, electron beam welding, friction or friction stir welding, and CMT welding, one may also consider laser or laser hybrid welding on account of the relatively small zone of thermal influence thereof.

According to a first embodiment of the chassis component according to the invention, the first metal layer and the at least second metal layer of the at least first component part are connected together at least at one place, especially at several places, preferably thermally joined together in a local manner. Thanks to the local thermal joined connection, it can be assured that no delamination occurs between the two metal layers in the installed state, shear between the metal layers can be prevented and the bending stiffness of the component part can be increased. Depending on the chassis component, the joining areas can be individually determined by means of simulation, and they may be provided in particular in the areas in which substantially no dynamic loads occur. Vice versa, certain characteristics can be established in the chassis component deliberately by means of the joined connection, in other words a positive influence may also be exerted on the characteristics of the chassis component.

According to another embodiment of the chassis component according to the invention, the first and/or the at least second metal layer of the at least first component part consists of an aluminum, a magnesium and/or preferably a steel material. Especially preferably, the first and the at least second metal layer consist of a steel material, preferably a microalloyed fine-grain steel or high-strength steel, such as a complex-phase steel with tensile strengths of up to 800 MPa or more, wherein the material thickness of the first metal layer of the at least first component part amounts to at least 0.2 mm, especially at least 0.5 mm, preferably at least 1.0 mm, especially preferably at least 1.5 mm. The material thicknesses of the first and the at least second metal layer may be the same or different, depending on the chassis component. A weight reduction of a chassis component is possible by using as the first metal layer for example a steel material, preferably a high-strength steel, and as the second metal layer an aluminum or magnesium material which has a smaller thickness as compared to the steel material, for the same material thickness.

For further improvement of the welding suitability in particular, according to another embodiment of the chassis component according to the invention the adhesive layer of the at least first component part may contain additives, especially welding additives. The thickness of the adhesive layer of the at least first component part, which may contain additives, amounts to at most 0.4 mm, especially at most 0.2 mm, preferably at most 0.1 mm. In order to ensure the damping characteristics of the structure-borne soundproofing composite material, a thickness of the adhesive layer of in particular at least 0.005 mm, of preferably at least 0.01 mm, of especially preferably at least 0.02 mm is provided.

According to another embodiment of the chassis component according to the invention, at least one second component part is connected to the first component part, especially in a form fit, force fit, and/or integrally bonded manner, wherein the component parts are preferably thermally joined together. For example, the at least second component part may consist of the same structure-borne soundproofing composite material as the first component part or is formed of a solid material, especially an aluminum, a magnesium or preferably a steel material. Depending on the configuration of the chassis component, a first as well as a second component part may be provided, for example also further component parts in the form of an open or closed profile, in the form of a half shell or a deep-drawn part.

According to a second aspect, the invention relates to a first method for the production of a chassis component containing at least one first component part made from a structure-borne soundproofing composite material with a first metal layer, at least one second metal layer and at least one damping layer, which is arranged partly or entirely across the surface between the metal layers, by the following method steps:
a) providing a first and at least one second metal semifinished part,
b) forming the first and the second metal semifinished part with the aid of suitable means to make a first and a second metal workpiece, wherein the geometries of the formed metal workpieces are attuned to each other such that they may be substantially congruent on the finished part,
c) integrally bonding the first and the second metal workpiece, forming the first and the second metal layer, via a damping layer arranged in between, which is an adhesive layer made from a silicone-containing material, in order to obtain a first component part.

According to a first embodiment of the first method according to the invention, the adhesive layer is applied to the first and/or second metal semifinished part before step a). The silicone-containing material may be applied for example in liquid, foamed, or solid form with the aid of suitable means. In the case of the liquid as well as the foamed form, the silicone-containing material can be applied, for example, by means of spraying, doctor blading, or especially preferably when the metal layer or the metal semifinished part is present as a band, by band coating (coil coating). Depending on the nature of the silicone-containing material, after the application in liquid form there may also be formed, for example, a fine-cellular foam structure. In solid form the silicone-containing material may be laminated in the form of a film, especially in combination with a cover film on the metal semifinished part. After the application of the silicone-containing material to the first and/or second metal semifinished part, a crosslinking may occur in the course of a heat treatment. The application of the silicone-containing material to the first and/or second metal semifinished part may also advantageously in combination with a cover film take on the function of a forming aid during the shaping process.

According to another embodiment of the first method according to the invention, the adhesive layer is applied to the first and/or second metal workpiece after step b). The silicone-containing material may be applied for example in liquid, foamed, or solid form with the aid of suitable means. In order to avoid repetition, reference is made to the preceding paragraph, with the exception that no coil coating can be performed.

According to another embodiment of the first method according to the invention, the adhesive layer during or after step c) is optionally heat-hardened with fixation of the metal workpieces by suitable means. During or after obtaining/creating the at least first component part from a structure-borne soundproofing composite material, this may be heat-treated in a further step, for example in order to positively influence the mechanical properties.

According to another embodiment of the first method according to the invention, during or after step c) the metal workpieces are connected together at least at one place, especially at several places, preferably thermally joined together in a local manner. In this way, the bending stiffness in the component part can be increased and a required operating strength in the installed state can be assured, in particular, a relative displacement of the metal workpieces with respect to each other can be substantially prevented (shear prevention). The thermally joined metal workpieces are preferably connected together by means of welding, especially fusion welding, preferably with the assistance of a welding wire. When using a welding wire, especially a metal powder filled wire, the quality of the weld can be further enhanced. Depending on the metal layer, especially in dependence on the material of the metal, the operator may employ corresponding welding wires, especially metal powder filled wires which are available on the market.

According to a third aspect, the invention relates to a second method for the production of a chassis component containing at least one first component part made from a structure-borne soundproofing composite material with a first metal layer, at least one second metal layer and at least one damping layer, which is arranged partly or entirely across the surface between the metal layers, by the following method steps:
d) providing at least one first semifinished part made from a structure-borne soundproofing composite material, which contains at least two metal layers and at least one damping layer arranged partly or entirely across the surface between them, which is an adhesive layer made from a silicone-containing material,
e) forming the at least one semifinished part with the aid of suitable means to make a first component part.

According to a first embodiment of the second method according to the invention, before, during or after step d) the metal layers are connected together at least at one place, especially at several places, preferably thermally joined together in a local manner. In this way, the bending stiffness in the component part can be increased and a required operating strength in the installed state can be assured, in particular, a relative displacement of the metal workpieces with respect to each other can be substantially prevented (shear prevention). The preferably thermally joined metal layers are preferably connected together by means of welding, especially fusion welding, preferably with the assistance of a welding wire. When using a welding wire, especially a metal powder filled wire, the quality of the weld can be further enhanced.

According to a fourth aspect, the invention relates to the use of the chassis component according to the invention in passenger cars, utility vehicles, trucks, special vehicles, buses, coaches, whether with an internal combustion engine and/or an electric drive, but also in rail vehicles, such as streetcars or passenger carriages. In order to avoid repetition, at this place as well reference is made to what was said before.

In the following, the invention shall be explained more closely with the aid of a drawing representing exemplary embodiments. The same parts are given the same references. There are shown

FIG. 1 a first exemplary embodiment of a chassis component according to the invention in an exploded view,

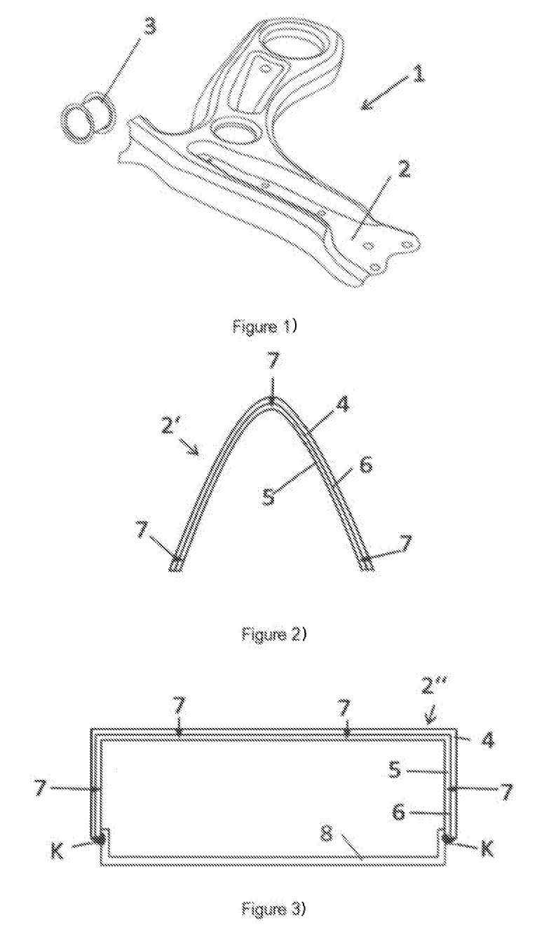

FIG. 2 a second exemplary embodiment of a chassis subcomponent according to the invention with at least one first component part in a schematic cross sectional view,

FIG. 3 a third exemplary embodiment of a chassis subcomponent according to the invention with at least one first component part in a schematic cross sectional view,

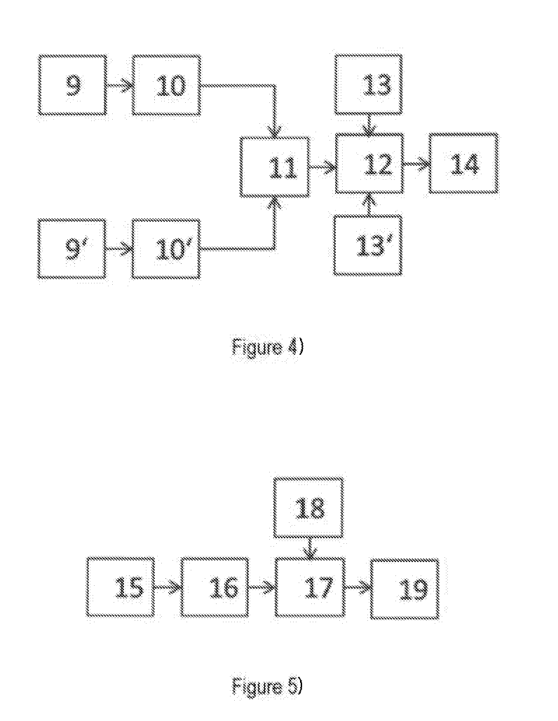

FIG. 4 a first exemplary embodiment of a first method according to the invention for producing a chassis component in a schematic sequence, and

FIG. 5 a first exemplary embodiment of a second method according to the invention for producing a chassis component in a schematic sequence.

FIG. 1 shows a first exemplary embodiment of a chassis component (1) according to the invention in the form of a cross link in an exploded view, containing at least a first component part (2) in the form of, for example, a deep-drawn half shell, having an L-shape, and at least one second component part (3) in the form of a sleeve, which is not yet connected to the deep-drawn half shell (2), preferably not yet thermally joined. We shall not further discuss here the passages or other openings/holes which are seen in FIG. 1. It is not evident that the deep-drawn half shell (2) is formed from a structure-borne soundproofing composite material with a first metal layer, at least one second metal layer and at least one damping layer, which is arranged partly or preferably entirely across the surface between the metal layers. The not-shown damping layer of the deep-drawn half shell (2) is an adhesive layer made from a silicone-containing material, which may contain additives. The silicone-containing material of the adhesive layer not only withstands transient temperatures above 200° C., but also shows no negative reaction in particular during a thermal joining, for example during a conventional metal gas welding, laser or laser hybrid welding, such as may be used for the component parts (2, 3) yet to be attached in order to complete the cross link 1 (chassis component). Other joining methods, as already described, are likewise usable. It is not represented that preferably the use of a steel material, especially a high-strength steel for the first and for the at least second metal layer is suitable for the component part 2, the material thickness of the first and/or the at least second steel layer being preferably at least 1.0 mm. The thickness of the adhesive layer between the steel layers of the component part 2, which may contain additives, is for example 0.04 mm.

The second exemplary embodiment described is a chassis subcomponent according to the invention in the form of a torsion beam axle, not completely represented. The torsion beam axle contains a first component part (2′) in the form of a torsion profile, which is shown in a schematic cross sectional view in FIG. 2. The torsion profile (2′) is an open profile, or it may also be a closed profile (not shown), having substantially a V-shaped cross section and formed from a structure-borne soundproofing composite material with a first metal layer (4), a second metal layer (5) and a damping layer (6), which is arranged entirely across the surface between the metal layers (4,5) and an adhesive layer (6) made from a silicone-containing material, which may contain additives. The metal layers (4, 5) consist preferably of a steel material, each with a material thickness of at least 0.5 mm in particular. The silicone-containing material (6) has a material thickness of 0.05 mm, for example. The torsion profile (2′) can for example be produced by means of a (not represented) deep drawing, edge bending, or roll profiling, preferably from a semifinished part consisting of a structure-borne soundproofing composite material. In order to avoid a delamination in the installed state and to prevent shear between the metal layers, especially to increase the bending stiffness of the component part, the metal layers (4,5) are connected together locally by preferably thermal joined connections (7). Other component parts not shown to complete the torsion beam axle are left and right longitudinal arms, which are preferably joined to the ends of the torsion profile not shown, preferably in a thermal manner, preferably by means of metal inert gas welding, laser or laser hybrid welding, or one of the already described joining methods. Other component parts not shown in the form of reinforcements, such as so-called shoes, or other attachment elements when necessary, if not already part of the longitudinal arms, may be joined to the torsion profile and/or the longitudinal arms, preferably in a thermal manner. The further component parts mentioned but not represented may consist individually or all of them may consist of a structure-borne soundproofing composite material. Of course, these component parts may also be formed from a solid material, especially an aluminum, a magnesium, or preferably a steel material.

The third exemplary embodiment described is a chassis component according to the invention in the form of an incompletely shown auxiliary frame. The auxiliary frame contains a first component part (2″) in the form of an upper half shell, which is shown in a schematic cross sectional view in FIG. 3. The upper half shell (2″) is an open profile, which has substantially a U-shaped cross section and is formed from a structure-borne soundproofing composite material with a first metal layer (4), a second metal layer (5) and a damping layer (6), which is arranged entirely across the surface between the metal layers (4,5), and an adhesive layer (6) made from a silicone-containing material. The metal layers (4,5) preferably consist of a steel material, each having a material thickness of especially preferably at least 0.5 mm. The silicone-containing material (6), which may contain additives, has a material thickness of 0.04 mm, for example. The upper half shell (2″) can be made for example by means of a deep drawing, not represented here, preferably from a semifinished part, which consists of a structure-borne soundproofing composite material. In order to avoid a delamination in the installed state and to prevent shear between the metal layers, especially to increase the bending stiffness of the component part, the metal layers (4,5) are connected together locally by preferably thermal joined connections (7). An at least second component part (8) in the form of a lower half shell, which can be made for example by means of deep drawing, may be formed from a solid material, such as a steel material, but also from an aluminum or magnesium material, for example if the weight of the chassis component needs to be reduced. Alternatively, and not represented here, the lower half shell (8) may also consist of a structure-borne soundproofing composite material. The two component parts/half shells (2″, 8) are secured at their projecting legs produced by the forming process in an overlapping position (not shown) and joined together preferably in a thermal manner by means of a weld in the form of a fillet weld (K) or for example alternatively by means of a butt joint connection, not shown. Other component parts not represented to complete the auxiliary frame may be additional component parts provided in the form of reinforcements and also component parts serving for height equalization, for example, in order to attach to a vehicle body, not shown, being connected preferably to the upper half shell (2″) and/or lower half shell (8) in a preferably thermal manner, preferably by means of metal gas welding, laser or laser hybrid welding or one of the already described joining methods.

FIG. 4 shows a first exemplary embodiment of a first method according to the invention for production of a chassis component in a schematic sequence. Billets may be in each use cut to size from an endless coil or billets already precut in a stack are provided in a stack in the form of a first metal semifinished part (step 9) and a second metal semifinished part (step 9′). The first and the second metal semifinished part is preferably a steel material, especially a high-strength steel. The material thickness of the first and/or second metal semifinished part is at least 0.3 mm, especially at least 0.5 mm, preferably at least 1.0 mm, especially preferably at least 1.5 mm. After the first and the second metal semifinished parts have been provided, a transfer occurs with the aid of means not shown to shaping devices, not shown, in which the first and the second metal semifinished part are formed with the aid of suitable means, such as dies, into a first metal workpiece (step 10) and a second metal workpiece (step 10′) the geometries of the formed metal workpieces being attuned to each other such that they are substantially congruent entirely across their surfaces on the finished part. After the shaping, a transfer occurs with the aid of means not shown to a composite manufacturing device, not shown (step 11), in which an integral bonding of the first and the second metal workpiece is done to create/obtain a first component part, these forming the first and the second metal layer, via a damping layer arranged in between, which is an adhesive layer made from a silicone-containing material. Preferably, and not represented, the adhesive layer is applied to the first and/or second metal semifinished part before (step 9, 9′). The silicone-containing material may be applied for example in liquid, foamed, or solid form with the aid of suitable means, not shown. In the case of the liquid and also the foamed form, the silicone-containing material can be deposited for example, by means of spraying or especially preferably, in particular when the metal layer or the metal semifinished part is present as a band, by means of band coating (coil coating). In solid form, the silicone-containing material can be laminated onto the metal semifinished part in the form of a film, especially in combination with a cover film. After the application of the silicone-containing material to the first and/or second metal workpiece, a crosslinking may occur in the course of a heat treatment, which may be done for example in the composite manufacturing device (step 11) and it may be heat-hardened, especially optionally with fixation of the metal workpieces by suitable means. Alternatively, the adhesive layer may be applied to the first and/or second metal workpiece after the forming (step 10, 10′). In this case, the silicone-containing material may be applied for example in liquid, foamed, or solid form with the aid of suitable means, not shown.

Preferably the metal workpieces are connected together at least at one place, especially at several places, preferably thermally joined together in a local manner in a welding device, not shown (step 12). In the welding devices not shown there occurs a preferably thermal joining by means of metal gas welding, laser or laser hybrid welding, or one of the joining methods already described, to a second and third component part, which are transferred after the providing step (step 13, 13′) to the welding device by means not shown. In the welding device there occurs preferably a fusion welding, especially with the assistance of a welding wire, preferably a filled wire, in order to improve the quality of the weld, for example. From the welding device, a finished chassis component is removed by means not shown (step 14), which may be for example a torsion beam axle, comprising at least one torsion profile (first component part, step 11) made from a structure-borne soundproofing composite material and thermally joined in each case to the ends of the torsion profile a left longitudinal arm (second component part, step 13′) and a right longitudinal arm (third component part, step 13′).

FIG. 5 shows a first exemplary embodiment of a second method according to the invention for the production of a chassis component in a schematic sequence. Billets are in each case cut to size from an endless coil or billets already precut are provided in a stack in the form of a semifinished part made from a structure-borne soundproofing composite material (step 15), which contains at least two metal layers, especially two metal layers made from a steel material, preferably a high-strength steel and especially at least one damping layer arranged partly or entirely across the surface in between, which is an adhesive layer made from a silicone-containing material. The material thickness of the first and/or the second metal layer is at least 0.3 mm, especially at least 0.5 mm, preferably at least 1.0 mm, especially preferably at least 1.5 mm. The material thickness of the adhesive layer made from silicone-containing material is between 0.005 mm and 0.4 mm, especially between 0.01 mm and 0.2 mm, preferably between 0.015 mm and 0.1 mm. After the semifinished part made from a structure-borne soundproofing composite material has been provided, a transfer occurs with the aid of means not shown to a shaping device, not shown (step 16), in which the semifinished part is formed with the aid of suitable means into a first component part. With the aid of means not shown here, the formed first component part made from a structure-borne soundproofing composite material is transferred to a welding device, not represented here. Preferably the two metal layers are connected together at least at one place, especially at several places, preferably thermally joined together in a local manner in the welding device, not shown (step 17). In the welding devices not shown there occurs a preferably thermal joining by means of metal gas welding, laser or laser hybrid welding, or one of the joining methods already described, to a second component part, which is transferred after the providing step (step 18) to the welding device by means not shown. In the welding device there occurs preferably a fusion welding, especially with the assistance of a welding wire, preferably a metal powder filled wire, in order to improve the quality of the weld, for example. From the welding device, a finished chassis component is removed by means not shown (step 19), which may be for example a cross link, comprising at least one deep-drawn half shell (first component part, step 16) made from a structure-borne soundproofing composite material and a thermally joined sleeve (second component part, step 18), compare FIG. 1.

The invention is not limited to the aforementioned chassis components, but rather it may also extend to other (all) chassis components, especially steering gears, such as cross links, longitudinal links, trailing links, double cross links, torsion beam axles, auxiliary frames, wheel disks of vehicle wheels, damper tubes of spring struts, containing at least one component part made from a structure-borne soundproofing composite material according to the invention.

The use of chassis components according to the invention is not limited to passenger cars, but rather it may also find application for chassis components in utility vehicles, trucks, special vehicles, buses, coaches, whether with an internal combustion engine and/or an electric drive, but also in rail vehicles, such as streetcars or passenger carriages.

### LIST OF REFERENCES

1 Chassis component
2, 2′, 2″ First component part
3 Second component part
4 First metal layer, first metal semifinished part, first metal workpiece
5 Second metal layer, second metal semifinished part, second metal workpiece
6 Damping layer, adhesive layer
7 Joined connection
8 Second component part
9-19 Steps, process steps, process sequence

1.-19. (canceled)

20. A chassis component comprising a first component part comprised of a structure-borne soundproofing composite material that includes a first metal layer, a second metal layer, and a damping layer disposed between the first and second metal layers, wherein the damping layer is an adhesive layer comprised of silicone-containing material.

21. The chassis component of claim 20 wherein the first metal layer and the second metal layer are thermally joined together in at least one place.

22. The chassis component of claim 20 wherein at least one of the first metal layer or the second metal layer comprises at least one of aluminum, magnesium, or steel.

23. The chassis component of claim 20 wherein a material thickness of the first metal layer is at least 0.2 mm.

24. The chassis component of claim 20 wherein the adhesive layer comprises additives.

25. The chassis component of claim 20 wherein a thickness of the adhesive layer is at most 0.4 mm.

26. The chassis component of claim 20 further comprising a second component part that is connected to the first component part in at least one of a form fit manner, a force fit manner, or an integrally bonded manner.

27. The chassis component of claim 26 wherein the second component part is comprised of either the structure-borne soundproofing composite material of which the first component part is comprised or a solid material.

28. A method for producing a chassis component comprising a first component part comprised of a structure-borne soundproofing composite material that includes a first metal layer, a second metal layer, and a damping layer disposed between the first and second metal layers, wherein the method comprises:
providing a first metal semifinished part and a second metal semifinished part;
forming the first metal semifinished part and the second metal semifinished part into a first metal workpiece and a second metal workpiece, wherein geometries of the first and second metal workpieces are attuned such that surfaces of the first and second metal workpieces are substantially congruent once the first component part is produced; and
integrally bonding the first and second metal workpieces to form the first metal layer and the second metal layer via the damping layer disposed between the first and second metal layers, thereby producing the first component part, wherein the damping layer is an adhesive layer comprised of a silicone-containing material.

29. The method of claim 29 comprising applying the adhesive layer to at least one of the first metal semifinished part or the second metal semifinished part prior to forming the first metal semifinished part and the second metal semifinished part.

30. The method of claim 29 comprising applying the adhesive layer to at least one of the first metal semifinished part or the second metal semifinished part after forming the first metal semifinished part and the second metal semifinished part.

31. The method of claim 29 further comprising heat-hardening the adhesive layer with fixation of the first and second metal layers during or after integrally bonding the first and second metal workpieces.

32. The method of claim 29 further comprising thermally joining the first and second metal workpieces in at least one place during or after integrally bonding the first and second metal workpieces via the damping layer.

33. The method of claim 32 comprising thermally joining the first and second metal workpieces by way of welding.

34. A method for producing a chassis component that includes a first component part, the method comprising:
providing a semifinished part comprised of a structure-borne soundproofing composite material that includes a first metal layer, a second metal layer, and a damping layer disposed between the first and second metal layers, wherein the damping layer is an adhesive layer comprised of silicone-containing material; and
forming the semifinished part to produce the first component part.

35. The method of claim 34 comprising thermally joining the first and second metal layers in at least one place before or during the providing of the semifinished part.

36. The method of claim 35 wherein the thermally joining comprises fusion welding the first and second metal layers with assistance of a welding wire.
